(19) United States
(12) Patent Application Publication
(10) Pub. No.: US 2006/0097476 A1
(43) Pub. Date: May 11, 2006

(54) Folding bicycle

(76) Inventor: Jouji Kobayashi, Tottori (JP)

Correspondence Address: ANDERSON, KILL & OLICK, P.C., 1251 AVENUE OF THE AMERICAS, NEW YORK,, NY, 10020-1182, US

(21) Appl. No.: 10/528,176

(22) PCT Filed: Mar. 10, 2003
(86) PCT No.: PCT/JP03/02820

§ 371 Date: Oct. 14, 2005

(30) Foreign Application Priority Data
Sep. 25, 2002 (JP) 2002316848
Nov. 5, 2002 (JP) 2002357336

(51) Int. Cl. B62K 15/00

(52) U.S. Cl. 280/287

(57) ABSTRACT

[Object] To provide a portable folding bicycle which allows the user to carry the bicycle with ease in a train, bus, or the like, without any trouble.

[Solving Means] A handle support 1 and a wheel support frame 2 are engaged with each other through a folding mechanism 3 which allows the user to turn the handle support 1 and the wheel support frame 2 around the turning axis extending along the lateral direction. Furthermore, the wheel support frame 2 includes a connection mechanism 4 which can be turned on a turning axis extending the longitudinal direction, thereby allowing connection of a rear wheel to the wheel support frame 2 while allowing switching between the turnable state, which allows the user to turn the rear wheel with the wheel support frame 2 as a turning axis, and the fixed state.

### TECHNICAL FIELD

The present invention relates to a carriable folding bicycle with excellent mobility.

### BACKGROUND ART

Conventional folding bicycles have a hinging portion around the middle portion of a frame for connecting a front wheel and a rear wheel, which allows folding of the bicycle (see Japanese Unexamined Patent Application Publication No. 2001-130471, for example). At the time of carrying the bicycle thus folded, the folded bicycle is packed in a bag.

### DISCLOSURE OF THE INVENTION

Conventional folding bicycles have an excessively large size even in the state wherein the bicycle is folded, leading to difficulty in the user carrying the bicycle in a train, bus, or the like. Furthermore, the conventional folding bicycles have a problem of excessively large weight, leading to difficulty in carrying thereof. It is an object of the present invention to provide a highly portable folding bicycle with a small size and small weight, which allows the user to carry the bicycle with ease in mass transit means such as a train, bus, and so forth.

In order to solve the aforementioned problems, with a folding bicycle according to the present invention, a handle support and a wheel support frame are engaged with each other through a folding mechanism which allows the user to turn the handle support and the wheel support frame around a turning axis extending along the lateral direction, with a connection mechanism being provided for the wheel support frame which can be turned on a turning axis extending along the longitudinal direction, thereby connecting a rear wheel to the wheel support frame while allowing switching between the turnable state, wherein the rear wheel can be turned with the wheel support frame as a turning axis, and the fixed state.

Furthermore, front wheels are disposed in parallel at a lower portion of the handle support, with a carrier being disposed at a somewhat upper portion of a lower portion of the handle support, which has a folding mechanism that allows switching between a flat state and an upright state, and with a support member being provided for the carrier, which has a function that allows switching between the turnable state and the flat state.

Furthermore, a foot board is disposed on the wheel support frame.

Furthermore, a universal joint is included at the lower portion of the handle support such that the handle support has an inclination as to an axis extending along the lateral direction, and passing through the middle portion of the universal joint, as an tilted axis, so as to extend backwards, thereby improving ease-of-use of steering. Furthermore, an arrangement may be made wherein a pair of front wheels is disposed in parallel at the end of a lower shaft of the universal joint, with the lower shaft being engaged with a head tube with an inclination of a suitable angle as to an axis passing through a middle portion of the universal joint and extending along the lateral direction as a tilted axis, so as to extend backward.

The folding bicycle having such a configuration described above allows the user to switch from the upright state to the flat state wherein the rear wheel is turned by 90° with the wheel support frame as a turning axis extending along the longitudinal direction by actions of the folding mechanism and the connection mechanism. Furthermore, such a configuration allows the user to fold the rear wheel side toward the handlebars, so as to achieve the upright state of the rear wheel and the handlebars. This reduces storage volume of the bicycle, i.e., enables folding down to a small storage size.

Furthermore, the folding bicycle, having a configuration wherein the front wheels are disposed in parallel at the lower portion of the handle support, allows the user to stably carry the bicycle in the folded state by gripping and pulling the upper portion of the handle. Furthermore, the folding bicycle having a configuration wherein the carrier is disposed at a somewhat upper portion of the lower portion of the handle support, allows the user to use the bicycle as a cart, as well as serving as a carrier of the bicycle during cycling. Furthermore, with the folding bicycle having a configuration wherein the carrier including the support member having a function which allows the user to switch between the turnable state and the fixed state, the bicycle folded in the storage state can be supported by the front wheels thus disposed in parallel and the aforementioned support member, thereby allowing the folded bicycle to stably stand on the ground by itself.

Furthermore, the folding bicycle including the footboard on the wheel support frame allows the user to place one foot on the footboard.

Furthermore, the bicycle, which includes a front-wheel structure formed of a pair of wheels, may include a balance mechanism having a configuration wherein the universal joint is formed at the lower portion of the handle support, the pair of front wheels is disposed in parallel at the end of the lower shaft of the universal joint, and the aforementioned lower shaft is engaged with the head tube so as to extend backwards with an inclination as to an axis passing through the middle portion of the universal joint and extending along the lateral direction as a tilted axis. With such a configuration wherein the lower shaft within the head tube has a predetermined inclination as to an axis extending along the lateral direction so as to extend backward, upon the user tilting the body of the bicycle to the left or right, the lower shaft within the head tube has an inclination in the lateral direction in addition to the aforementioned inclination in the longitudinal direction, as well as leading to a situation wherein the pair of front wheels disposed in parallel, both of which have been in contact with the ground, assumes an angle as to the ground level. With the aforementioned configuration, the pair of front wheels is turned with the lower shaft within the head tube as a turning axis by actions of returning to the state wherein the both front wheels stay on the ground due to the weight of the bicycle. As a result, the pair of front wheels is automatically turned at an angle corresponding to tilting by the user. Furthermore, the turning angle of the lower shaft thus provided is transmitted to the handlebars through the universal joint, whereby the handlebars are turned at the same angle with the handle support as a turning axis.

### BRIEF DESCRIPTION OF THE DRAWINGS

FIG. 1 is a partially cutaway perspective view which shows a folding bicycle according to an embodiment.

FIG. 2 is a partial perspective view which shows a folding mechanism.

FIG. 3 is a partial perspective view which shows a connection mechanism.

FIG. 4 is a perspective view which shows the folding bicycle according to the embodiment.

FIG. 5 is a diagram which shows an example of use of the folding bicycle.

FIG. 6 is a diagram which shows an example of use of the folding bicycle.

FIG. 7 is a diagram which shows an example of use of the folding bicycle.

FIG. 8 is a diagram which shows an example of use of the folding bicycle.

FIG. 9 is a partially cutaway perspective view which shows a balance mechanism according to an embodiment.

FIG. 10 is a partially cutaway perspective view which shows the balance mechanism according to the embodiment.

FIG. 11 is a diagram which shows inclination of a universal joint as to the direction of motion.

FIG. 12 is a plan view for describing a state wherein the body of the bicycle is tilted.

FIG. 13 is a front view for describing the state wherein the body of the bicycle is tilted.

### REFERENCE NUMERALS

1: handle support

2, 2a, 2b: wheel support frame

3: folding mechanism

4: connection mechanism

5: rear wheel

6: front wheel

7: carrier

8: support member

9: footboard

11. 12: metal member having a U-shaped cross-section

13, 33: turning axis

14: pressing spring

18: driving mechanism

21: saddle

21a: saddle support frame

22: pedal

22a: pedal support opening

23: handle

24: baggage

31, 32: bracket

34: guide slot

35: slide-shaft opening

36: slide shaft

37: cam bearing shaft

38: pulling spring

39: cam

40: folding lever

41, 41a, 41b: partition

42: stopper

43: clutch plate

44: clutch-pawl hole

45: shaft

46: clutch lever

47: pressing spring

10: universal joint

10a: lower shaft

10b: middle portion of the universal joint

10c: upper shaft

15: head tube

61: wheel shaft

### BEST MODE FOR CARRYING OUT THE INVENTION

Description will be made regarding embodiments according to the present invention with reference to the drawings.

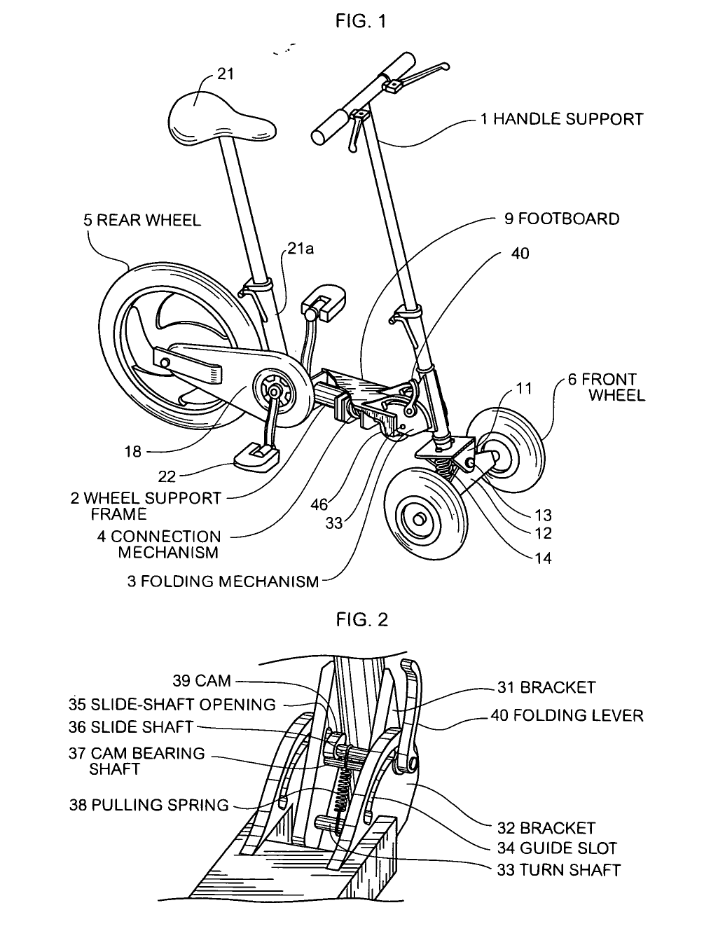

As shown in FIG. 1, a folding bicycle according to an embodiment of the present invention has a configuration wherein a handle support 1 is engaged with a wheel support frame 2 through a folding mechanism 3 which allows switching between a fixed state and a turnable state. Furthermore, a connection mechanism 4 is provided for the aforementioned wheel support frame 2, thereby allowing switching between the fixing state wherein a rear wheel 5 is fixed and the turnable state which allows the user to turn the rear wheel 5 with the aforementioned wheel support frame 2 as a turning axis.

The lower portion of the handle support 1 is fixed to a metal member 11 having a U-shaped cross-section. Furthermore, another metal member 12 having a U-shaped cross-section is engaged with the metal member 11 having a U-shaped cross-section so as to face one another. Furthermore, a turn shaft 13 is passed through the faces of the engaging portion thus formed, along the direction orthogonal to the faces thereof, i.e., the longitudinal direction of the bicycle, thereby allowing the user to turn the upper and lower metal members 11 and 12. Furthermore, front wheels 6 are mounted on both ends of the lower metal member 12. Furthermore, a pair of pressing springs 14 is disposed within the engaging portion of the metal members 11 and 12, each of which has a U-shaped cross-section, with the turn shaft 13 introduced therebetween, to keep the handle support 1 from tilting over sideways.

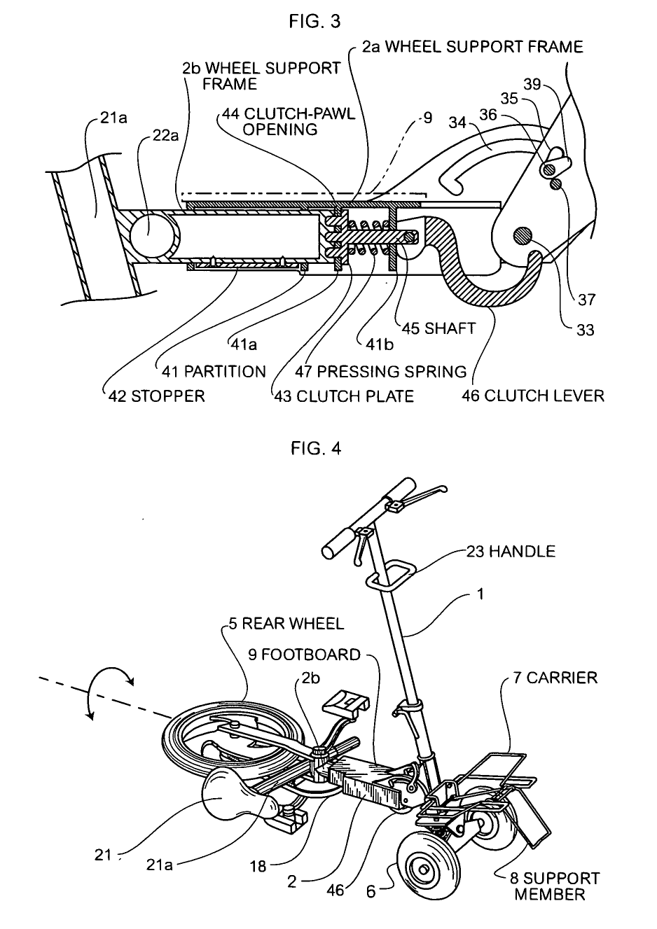

FIG. 2 and FIG. 3 are a perspective view and a side view of the folding mechanism 3 according to the present embodiment, respectively. The handle support 1 has a pair of plate-shaped brackets 31 so as to protrude from the lower portion thereof. In the same way, the wheel support frame has a pair of plate-shaped brackets 32 so as to protrude from the end thereof. The pair of brackets 32 is engaged with the pair of brackets 31 introduced therebetween, as well as the pair of brackets 31 and the pair of brackets 32 facing one another. Furthermore, a turn shaft 33 is passed through the faces of the engaging portion thus formed, along the direction orthogonal to the faces thereof, i.e., in the lateral direction of the bicycle, which allows turnable connection between the handle support 1 and the wheel support frame 2. A guide slot 34 having hooking portions on both ends is formed on each bracket 32, in the shape of an arc which has the center matching the position of the turn shaft 33, for slidably supporting a slide shaft 36. On the other hand, a slide-shaft opening 35 is formed on each bracket 31 at a position matching the position of one of the hooking portions of the guide slot 34. The slide shaft 36 is passed through the slide-shaft openings 35 and the guide slots 34 so as to be slidably supported without falling out of the slots. With such a configuration, a cam bearing shaft 37 is fixed to the bracket 31. Furthermore, the turn shaft 33 is engaged with the slide shaft 36 through a pulling spring 38. Furthermore, a cam 39 is fixed to a suitable position of the slide shaft 36. Furthermore, a folding lever 40 is fixed to the end of the slide shaft 36.

FIG. 3 is a cross-sectional diagram which shows the connection mechanism 4 according to the present embodiment. A wheel support frame 2a disposed along the longitudinal direction of the folding bicycle has a cell structure including a predetermined number of partitions 41. A tube-shaped wheel support frame 2b including a pedal support opening 22a, a saddle support frame 21a, and the like, formed on the rear end thereof, is inserted to the wheel support frame 2a through the multiple partitions 41. At this time, a stopper 42 is fixed with screws so as to prevent the wheel support frame 2b from falling out. Furthermore, four pawls formed on the perimeter of the tip face of a clutch plate 43 with the center of the tip face as the center, at a pitch of 90°, are fit to holes formed on the tip face of the wheel support frame 2b with a partition 41a introduced therebetween. Note that clutch-pawl openings 44 are formed on the face of partition 41a. Furthermore, a shaft 45 protruding from the middle portion of the clutch plate 43 is passed through a partition 41b. Furthermore, an arc-shaped clutch lever 46 is engaged with the tip of the shaft 45 with a connection pin, as well as including a pressing spring 47 between the clutch plate 43 and the partition 41b. The above-described connection mechanism and folding mechanism have been described for exemplary purposes only, and the connection mechanism and the folding mechanism employed in the present invention are not restricted in particular.

FIG. 4 shows the folding bicycle in the fixed state wherein the rear wheel with a driving mechanism 18 is turned in one direction by 90°, with the wheel support frame, which forms a part of the longitudinal shaft of the bicycle, serving as a turning axis.

The folding bicycle shown in FIG. 4 includes front wheels 6 in parallel at the lower portion of the handle support 1. Furthermore, the folding bicycle includes a carrier 7 at a somewhat upper portion of the lower portion of the handle support 1, having a folding mechanism which allows switching between the flat state and the upright state. Furthermore, a support member 8 serving as a stand is provided for the carrier, which has a mechanism for switching between the turnable state and the fixed state.

Furthermore, a footboard 9 is fixed on the wheel support frame 2.

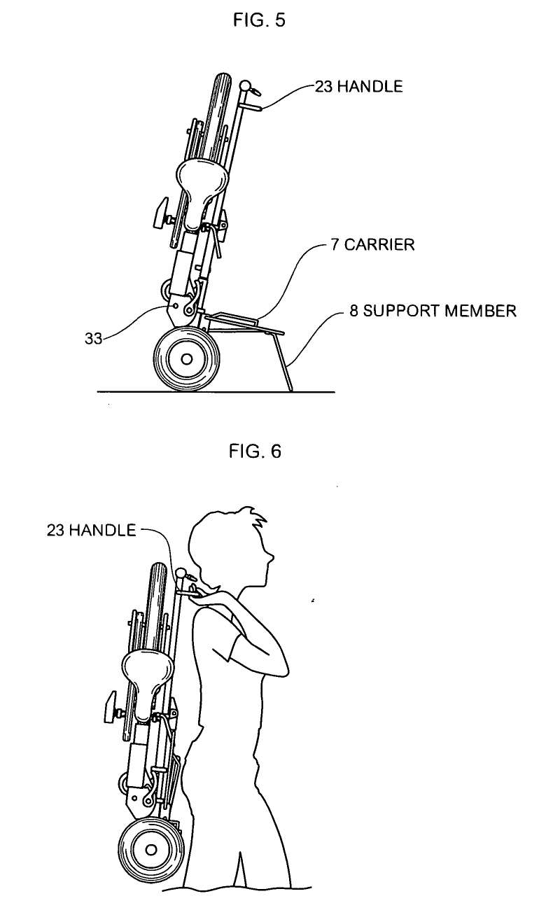

FIG. 5 shows the folding bicycle in the state wherein the bicycle is folded with the foldable carrier 7 and the support member 8 being spread such that the bicycle stands by itself.

FIG. 6 shows the folding bicycle including a handle 23 formed at the upper portion of the handle support 1, with the carrier being in the upright state, and with the support member being folded, which allows the user to shoulder the folding bicycle.

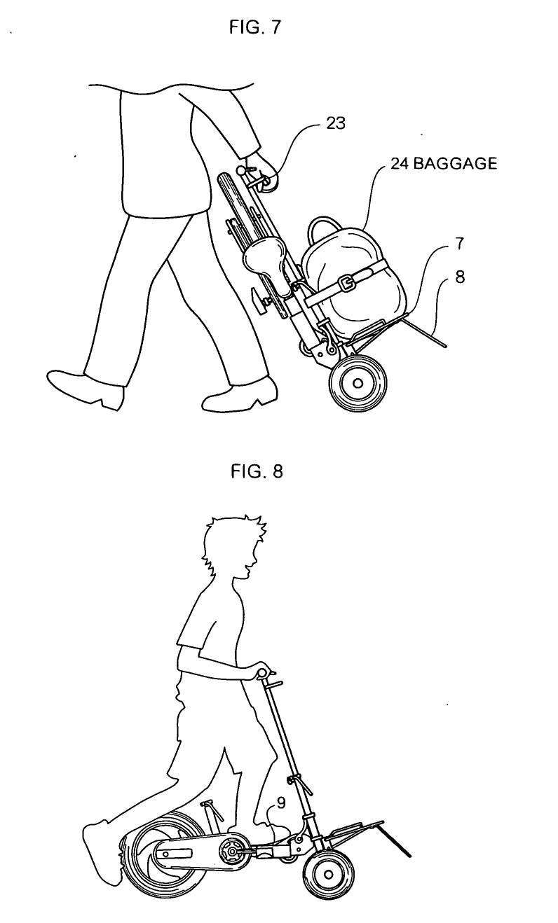

FIG. 7 shows an example of high-mobility use of the folding bicycle in the storage state wherein the bicycle is folded, serving as a cart with a baggage 24 on the carrier 7.

FIG. 8 shows the folding bicycle in the state wherein the saddle 21 is removed, which allows the user to enjoy comfortable cycling with the foot of the user on the footboard 9.

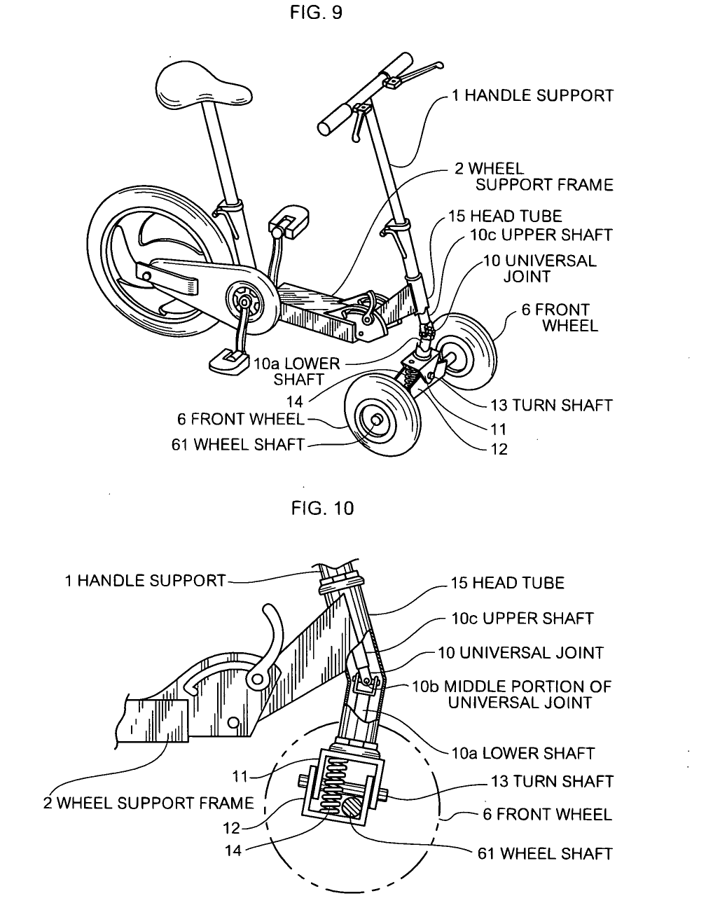

FIG. 9 and FIG. 10 show a folding bicycle according to another embodiment of the present invention having a configuration wherein a universal joint 10 fixed to the lower portion of the handle support 1 is fit and fixed to a head tube 15 formed in a bent shape having a bent portion around at a middle portion thereof such that both ends extend backwards with the upper portion corresponding to an upper shaft 10c of the universal joint 10 being tilted at an angle α of around 15°, and with the lower portion corresponding to a lower shaft 10a of the universal joint 10 being tilted at an angle β of around 10°. Note that the aforementioned values of the angles have been obtained based upon experimental results, and the angles employed in the present embodiment are not restricted to the aforementioned values.

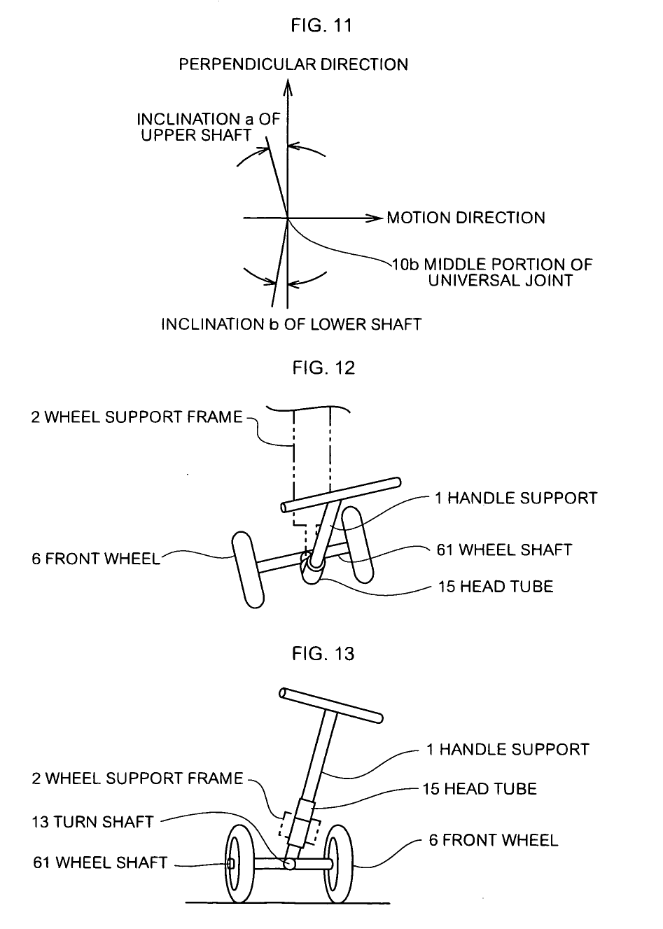

FIG. 11 shows the inclination of the universal joint as to the direction of motion.

FIG. 12 is a plan view which shows the state wherein the body of the folding bicycle is tilted.

FIG. 13 is a front view which shows the state wherein the body of the folding bicycle is tilted.

### INDUSTRIAL APPLICABILITY

An arrangement according to the present invention having the above-described configuration has the advantages as follows.

With the folding bicycle according to the present embodiment, the handle support and the wheel support frame are engaged with each other with the folding mechanism which allows the user to turn the handle with the wheel support frame as an turning axis extending along the lateral direction. Furthermore, the rear wheel is connected to the aforementioned wheel support frame with the connection mechanism which allows the user to turn the rear wheel with the aforementioned wheel support frame as a turning axis extending along the longitudinal direction. Such a configuration allows the user to fold the folding bicycle down to a small storage size, thereby allowing the user to carry the bicycle with ease in mass transit means such as a train, bus, and so forth. That is to say, the present invention provides a folding bicycle with excellent mobility.

Furthermore, the folding bicycle according to the present invention includes the front wheels disposed in parallel at the lower portion of the handle support, and the carrier at a somewhat upper portion of the lower portion of the handle support, which has the folding mechanism that allows switching between the flat state and the upright state; the carrier including the support member which has a function for switching between the turnable state and the fixed state. Such a configuration allows the user to use the folding bicycle as a carrier with high mobility, as well as allowing the user to fold the folding bicycle so as to achieve a storage state wherein the folding bicycle stands up by itself.

Furthermore, the folding bicycle including the foot board on the wheel support frame allows the user to enjoy cycling with one of the feet of the user on the foot board, while kicking the ground by the other foot.

Furthermore, the folding bicycle according to another embodiment has a configuration wherein a pair of the front wheels are disposed in parallel at the end of the lower shaft of the universal joint formed at the lower portion of the handle support; the lower shaft of the universal joint being engaged with the head tube with an inclination of a suitable angle as to an axis passing through the middle portion of the universal joint extending along the lateral direction as a tilted axis. With such a configuration, upon tilting the body of the bicycle sideways, the pair of the front wheels disposed in parallel is automatically steered toward a direction and at an angle corresponding to the tilt of the bicycle, as well as automatically steering the handlebars at a corresponding angle. This allows the user to steer the bicycle by weight shift alone, as well as steering with the handlebars, thereby providing natural and comfortable steering functions.

1. A folding bicycle wherein a handle support (1) and a wheel support frame (2) are engaged with each other through a folding mechanism (3) which allows the user to turn said handle support (1) and said wheel support frame (2) on a turning axis extending along the lateral direction,
and wherein a connection mechanism (4) is provided for said wheel support frame (2) which can be turned on a turning axis extending along the longitudinal direction, thereby connecting a rear wheel (5) to said wheel support frame (2) while allowing switching between the turnable state, wherein said rear wheel can be turned with said wheel support frame (2) as a turning axis, and the fixed state.

2. A folding bicycle according to claim 1, wherein front wheels (6) are disposed in parallel at a lower portion of said handle support (1),
and wherein a carrier (7) is disposed at a somewhat upper portion of a lower portion of said handle support (1), which has a folding mechanism that allows switching between a flat state and an upright state,
and wherein a support member (8) is provided for said carrier (7), which has a function that allows switching between the turnable state and the flat state.

3. A folding bicycle according to claim 1, wherein a foot board (9) is disposed on said wheel support frame (2).

4. A stable steering mechanism of a bicycle, wherein a universal joint (10) is formed at a lower portion of said handle support (1),
and wherein said front wheels (6) are disposed in parallel at the end of a lower shaft (10a) of said universal joint (10),
and wherein said lower shaft (10a) is engaged with a head tube (11) with an inclination of a suitable angle as to an axis passing through a middle portion (10a) of said universal joint (10) and extending along the lateral direction as a tilted axis, so as to extend backward.
